(19) United States
(12) Patent Application Publication
(10) Pub. No.: US 2007/0040801 A1
(43) Pub. Date: Feb. 22, 2007

(54) Method and apparatus for displaying movement of input device in on-screen display (OSD) area

(75) Inventor: Eu-min Chung, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/494,532

(22) Filed: Jul. 28, 2006

(30) Foreign Application Priority Data
Aug. 17, 2005 (KR) 2005-75285

(51) Int. Cl. G09G 5/08

(52) U.S. Cl. 345/158

(57) ABSTRACT

A wireless display apparatus and a method of displaying an input device movement in an OSD area in a wireless display apparatus. The method includes receiving information on the movement of an input device, such as a mouse, displaying a pointer position of the input device in an on-screen display (OSD) area according to the information on the movement, receiving graphical data from a computer, containing information on the mouse's movement or mouse button activation, and outputting the graphical data at the displayed pointer position.

### CROSS-REFERENCE TO RELATED APPLICATIONS

This application claims the benefit of Korean Patent Application No. 2005-75285, filed Aug. 17, 2005, in the Korean Intellectual Property Office, the disclosure of which is incorporated herein in its entirety by reference.

### BACKGROUND OF THE INVENTION

1. Field of the Invention

Aspects of the present invention relate to a wireless display apparatus and, more particularly, to an apparatus and a method that displays a movement of an input device in an on-screen display (OSD) area.

2. Description of the Related Art

Wire cables are used to transfer data between peripheral devices and computers. However, due to limitations, complexity, and installation difficulties of wire cables, the need for wireless interfaces has increased.

In line with the research and development of wireless interfaces, wireless mice and keyboards are now available. Meanwhile, a way of using wireless signals as opposed to wire cables to connect monitors and computers has been proposed.

Although image compression technology and data transfer rates have recently progressed rapidly, a currently available solution does not prevent a delay, easily recognized by a user, from occurring when image information above a standard definition (SD) level is wirelessly transmitted.

Korean Unexamined Patent Publication No. 2003-61867 discloses a computer having a monitor with a wireless mouse and a keyboard-receiving unit. However, that publication discloses that the signals of a wireless mouse or keyboard transmitting unit to the monitor receiving unit bypass the computer, as opposed to a method of preventing a delay in a wireless monitor.

FIG. 1 is a drawing illustrating the wireless transmission and reception of data between a monitor and a computer. Graphical data is generated in a computer 20 and compressed by an image-compressing unit 24. Then, the compressed image is wirelessly transmitted via a data-transmission unit 28. A data-receiving unit 18 receives the compressed image and transmits it to a restoring unit 14, which then restores the compressed image and transmits graphical data to a liquid crystal display (LCD) device 30.

Some delays occur when image information generated by the computer 20 is transmitted to the LCD display device 30 via the aforementioned processes. The delays occur mainly because a wireless protocol bit rate is limited, and thus, the image information is not transmitted in real-time but is delayed by 1 to 2 seconds. Hence, when a user uses an input device, input information is not reflected for 1 to 2 seconds later, which is a problem.

### SUMMARY OF THE INVENTION

Aspects of the present invention solve the aforementioned and/or additional problems existing in the related art, and an aspect of the present invention removes a time delay created when a wireless monitor is used by removing delay created when an input device transmits a signal to the wireless monitor to output to a display, thus improving performance.

Another aspect of the present invention reduces an amount of data transmitted by processing an image change, caused by an input device, in a monitor.

The above stated aspects as well as other aspects, features and advantages, of the present invention will become clear to those skilled in the art upon review of the following description.

According to an aspect of the present invention, there is provided a method of displaying an input device movement in an on-screen display (OSD) area in a wireless display apparatus, the method includes receiving information on the movement of an input device, displaying a pointer position of the input device in an OSD area according to the information on the movement, receiving graphical data, from a computer, containing information on the input device's movement, and outputting the graphical data at the displayed pointer position.

According to another aspect of the present invention, there is provided a method of displaying an input device movement in an OSD area in a wireless display apparatus, the method includes generating information on the movement according to an operation, transmitting the generated information to a wireless display apparatus, and transmitting the information to a computer that outputs graphical data via the wireless display apparatus.

According to a further aspect of the present invention, there is provided a wireless display apparatus including an input-device control-signal-receiving unit that receives information on movement of an input device, an OSD controller that displays a pointer position in an OSD area according to the received information, an image-receiving unit that receives graphical data from a computer, the graphical data containing information on the input device's movement, and an output unit that outputs the graphical data at the displayed pointer position.

According to a still further aspect of the present invention, there is provided a wireless display apparatus including an output unit including an OSD area where a pointer position is displayed when an input device is moved, and a data-receiving unit that receives graphical data changed according to the pointer position of the input device using a wireless communication protocol, wherein the output unit outputs the graphical data.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a drawing illustrating a wireless transmission and reception of data between a monitor and a computer;

FIG. 2 illustrates a case where a display apparatus receives signals of an input device, outputs the signals to an OSD and transmits movement information according to the signals of the input device to a computer according to an embodiment of the present invention;

FIG. 3 illustrates a configuration of a mouse input device that transmits information on its movement to a wireless display apparatus and a computer according to an embodiment of the present invention;

FIG. 4 is a flowchart illustrating a process in which information on cursor movement is received and output to an OSD area according to an embodiment of the present invention; and

FIG. 5 illustrates a case where the position of a mouse is output to an OSD area according to an embodiment of the present invention.

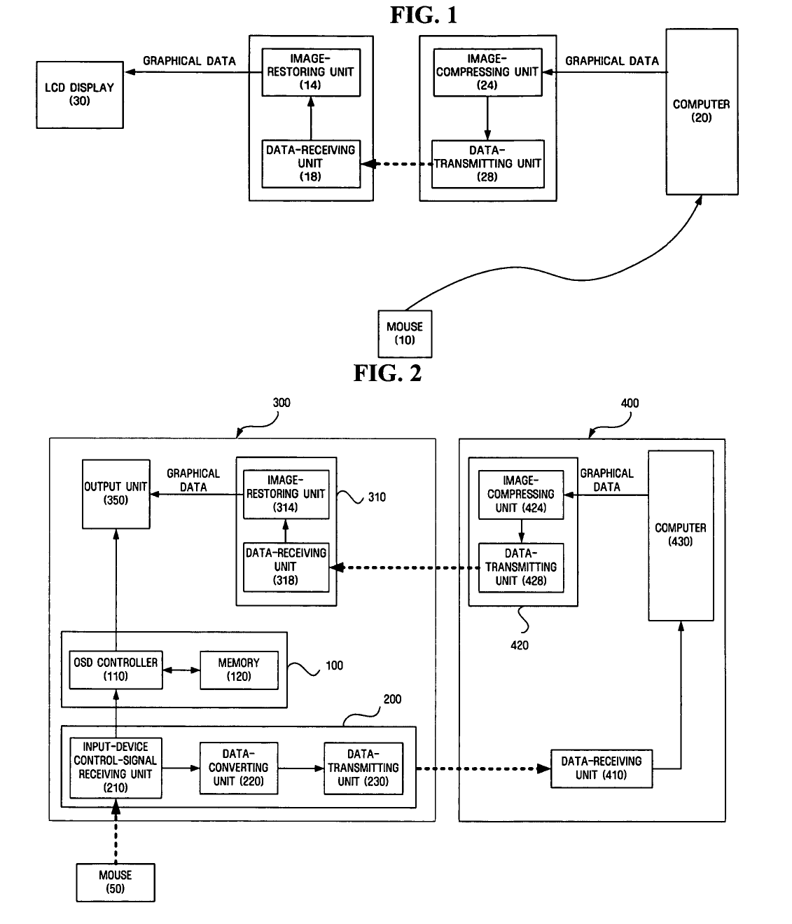

### DETAILED DESCRIPTION OF THE INVENTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention will be described hereinafter with reference to block diagrams or flowchart illustrations of apparatuses and methods of processing flash memory data according to embodiments thereof. It will be understood that each block of the flowchart illustrations and combinations of blocks in the flowchart illustrations can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, implement the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instructions that implement the function specified in the flowchart block or blocks. The computer program instructions may also be loaded into a computer or other programmable data processing apparatus to cause a series of operations to be performed in the computer or other programmable apparatus to produce a computer implemented process such that the instructions that execute in the computer or other programmable apparatus provide operations implementing the functions specified in the flowchart block or blocks.

Each block of the block diagrams may represent a module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in reverse order depending upon the functionality involved.

When a cursor is moved by an input device such as a mouse, display of the cursor movement on a wireless display apparatus can be delayed. Therefore, a user's precise work can be interrupted and delayed because of the display's delay. On the other hand, when the wireless display apparatus receives a first cursor movement signal directly from an input device movement, displays it on an on-screen display (OSD), and then receives a second cursor movement signal from a computer also in response to the input device movement, cursor movement information is immediately displayed on the screen.

As an example of an input device, a mouse is described in this specification but the present invention is not limited thereto. The input device can include such devices as a mouse, a tablet pen, a trackball, a touch pad, a remote controller, a touch screen and a joystick, as well as others.

The term unit, i.e., module or table as used herein, refers to, but is not limited to, a software or hardware component, such as a Field Programmable Gate Array (FPGA) or an Application Specific Integrated Circuit (ASIC), which performs certain tasks. A module may advantageously be configured to reside on the addressable storage medium and execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

FIG. 2 illustrates a case where a display apparatus receives signals of an input device, outputs the signals to an OSD, and transmits movement information according to the signals of the input device to a computer according to an embodiment of the present invention.

A wireless display apparatus 300 includes four parts: an output unit 350 that outputs images, an image processing unit 310 that wirelessly receives compressed graphical data from the computer central processing unit (CPU) and restores the graphical data, an OSD processing unit 100 that controls the OSD, and an input signal processing unit 200 that receives and processes a control signal generated by the input device motion and/or the input device function keys, such as tapping a touch pad or activating a mouse button.

The output unit 350 outputs graphical information. The wireless display apparatus can output the information to various modules such as a liquid crystal display (LCD), a plasma display panel (PDP), and an organic light emitting diode (OLED), and the output unit includes LCD modules, PDP modules, and OLED modules. In addition to these modules, the on-screen display unit that outputs images on the wireless display apparatus is another example of the output unit 350.

An input-device control-signal receiving unit 210 of the input signal processing unit 200 receives a control signal generated when an input device such as a mouse 50 is moved and/or a function key is activated. In a moving input device such as a mouse or a joystick, the control signal includes information on how far and in which direction the input device has moved or information required to calculate the direction and the distance. The input-device control-signal-receiving unit 210 receives a signal generated when a mouse 50 is moved, and converts the signal to movement information. The input-device control-signal-receiving unit 210 also calculates how far and in which direction the mouse 50 has moved, and transmits such information to an OSD controller 110 and to a data converting unit 220 as described later. The input-device control-signal receiving unit 210 may transmit a relative position of the mouse 50 compared with the previous position of the mouse 50 to the OSD controller 110 in order to output the signal in an OSD overlay area. When information on the distance moved and direction moved is transmitted to a computer 430, a pointing position such as a cursor, is changed.

The OSD controller 110 reflects the movement information of the input device according to the received control signal, and outputs the signal in the OSD overlay area. The signal is output in such a way that the current position of the mouse 50 is recognized. The current position refers to a position where the cursor is displayed, i.e., a pointing position. The current position also refers to the position on the screen where a click or a button input from the input device such as a joystick, a tablet pen, or a touch panel in addition to the mouse 50, is carried out.

The OSD controller 110 stores a current position of the mouse 50 in memory 120 based on information on the previous cursor movement so that when the mouse 50 is moved, the new position of the mouse 50 can be displayed based on the information. The memory 120 provides a standard position so that the OSD controller can output the current position of the mouse 50. Accordingly, the mouse's position which is stored in the memory 120 is continuously updated when a user moves the mouse 50.

A control signal from the input-device control-signal receiving unit 210 modifies information on the position of the mouse in a data-converting unit 220 in order to convert a resolution of the OSD overlay area to that of computer graphics by comparing the OSD overlay area resolution to a computer graphics resolution because in general, the resolutions of the OSD overlay area and the computer graphics are different. The modified information on the position of the mouse 50 is transmitted to a first data-receiving unit 410 via a first data-transmitting unit 230. The first data-transmitting unit 230 and the first data-receiving unit 410 wirelessly transmit and receive data. The first data-transmitting unit 230 and the first data-receiving unit 410 can transmit and receive data using several optical, radiowave, ultrasonic, or other wireless protocols such as IEEE 802.11a, 802.11b, and 802.11g, Bluetooth, or wireless universal serial bus (USB), but are not limited thereto.

A computer system 400 includes the first data-receiving unit 410 that receives information on the position of the input device such as the mouse 50, a first image-processing unit 420 that compresses and transmits images to a wireless display apparatus, and a computer CPU 430. The first data-receiving unit 410 and the first image-processing unit 420 may be connected to the computer CPU 430 within a housing, or located on the exterior of the computer CPU 430. That is, the computer system 400, from the point of view of a user, includes a computer with external peripheral devices and/or built-in internal peripheral devices.

The computer CPU 430 performs graphics processing according to the received data on the position of the mouse 50. When the cursor is displayed at a position to which the mouse 50 has moved or a function is executed, such as a change in cursor shape changed by the mouse 50, the computer CPU 430 executes an operation to output the new position or cursor shape. When the output graphics data is transmitted to the first image-processing unit 420, an image-compressing unit 424 compresses images and a second data-transmitting unit 428 wirelessly transmits the compressed images.

A second data-receiving unit 318 of a second image-processing unit 310 of the wireless display apparatus 300 receives the compressed images, and an image-restoring unit 314 restores the compressed images and outputs graphics data to the output unit 350. Accordingly, the CPU modified information in the images created by controlling the mouse 50 is output to a position where the mouse position is in the OSD area. Because the user can see the position of the mouse using information on the position of the cursor displayed on the OSD overlay area, a delay in the most recent information on the mouse position does not cause a significant problem.

The second data-transmitting unit 428 and the second data-receiving unit 318 can transmit and receive data using several optical, radiowave, ultrasonic, or other wireless protocols such as IEEE 802.11a, 802.11b, and 802.11g, Bluetooth, or wireless universal serial bus (USB), but are not limited thereto.

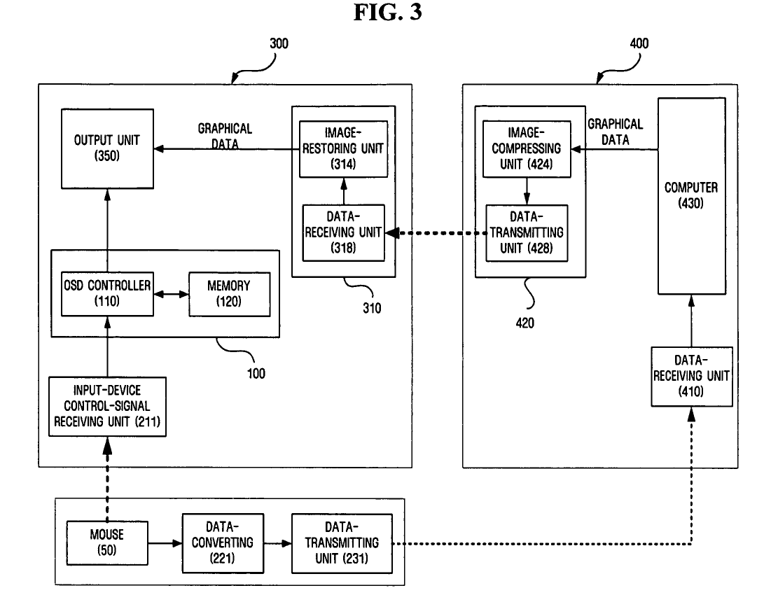

FIG. 2 illustrates the process where a wireless display apparatus receives and processes information on cursor movement and then transmits the information to a computer. FIG. 3, on the other hand, illustrates a configuration of an input device, e.g., a mouse 50, which transmits information on the cursor movement to a wireless display apparatus and a computer. In contrast to the embodiment of the present invention shown in FIG. 2, a data-converting unit 221 and a data-transmitting unit 231 are connected to a mouse 50 in the embodiment shown in FIG. 3. However, the fact that a control signal generated by the mouse 50 is transmitted to an input-device control-signal receiving unit 211 of a wireless display apparatus 300 and output via the OSD-processing unit 100 has been previously described with reference to FIG. 2, thus, further detailed description thereof will be omitted here.

In FIG. 3, in order for a computer to transmit information on cursor movement, the information in pixels may be converted according to the computer resolution in an apparatus that is disconnected from the wireless display apparatus but connected to the mouse 50 or in the mouse 50 that is connected to such a converter apparatus.

A control signal of the mouse is converted into data information based on the resolution of the computer and the OSD overlay area of the wireless display apparatus 300. The converted information is wirelessly transmitted to the data-receiving unit 410 of the computer system via the data-transmitting unit 231.

A process in which the data is processed in the computer system 400, and graphical data is compressed and transmitted to the wireless display apparatus 300 that restores the graphical data has been previously described with reference to FIG. 2. Thus, further detailed description thereof will be omitted here.

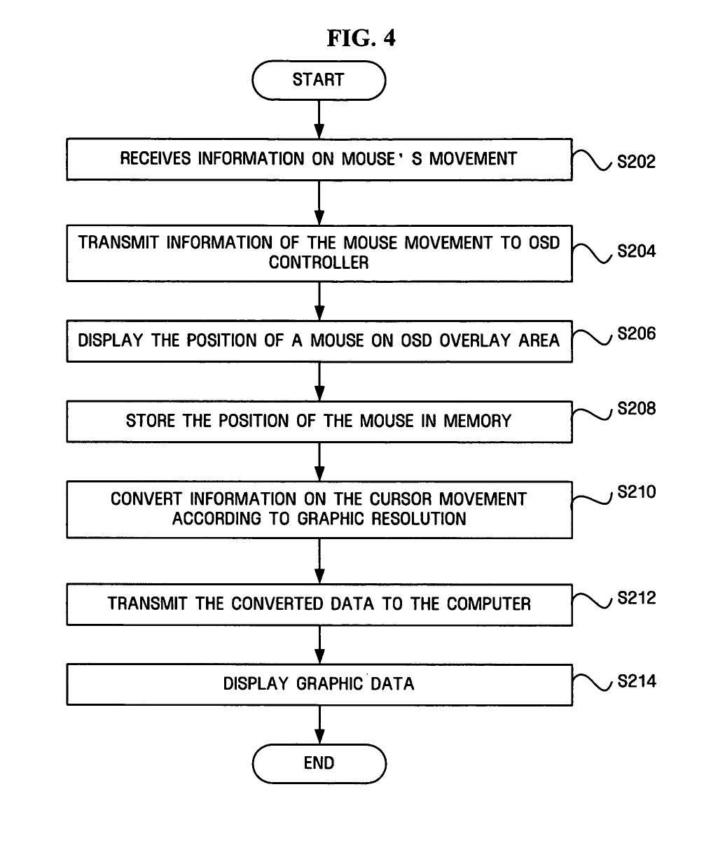

FIG. 4 is a flowchart illustrating a process in which information on cursor movement is received and output to an OSD area according to an embodiment of the present invention.

In operation S202, a wireless display apparatus receives information of a mouse movement, which includes a control signal of the mouse, a direction of movement and a distance moved as described above. The movement information is transmitted to an OSD controller S204. The OSD controller outputs the position of the mouse in an OSD overlay area in operation S206, and stores information thereon in memory in operation S208.

The stored information is referred to when the mouse is moved again later. In operation 210, the information of the mouse movement is converted corresponding to the resolution of the display. This may be executed in a wireless display apparatus having the same structure as that of FIG. 2, and in a device connected to a mouse or inside the mouse having the same structure as that of FIG. 3. In operation S212, the converted data is transmitted to the computer. New graphical data is generated by combining the transmitted data with images currently output by the computer, and is transmitted to the wireless display apparatus. In operation S214, the wireless display apparatus receives and outputs the graphical data.

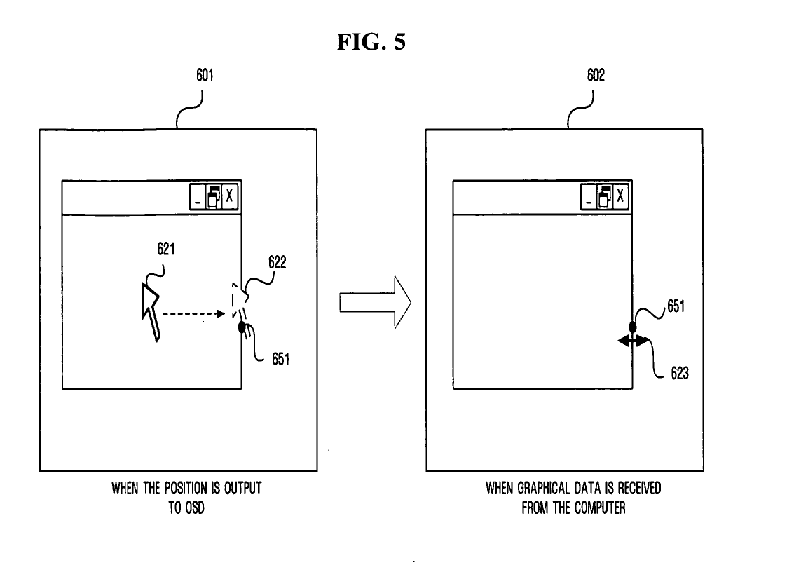

FIG. 5 illustrates a case where the position of a mouse is output to an OSD area according to an embodiment of the present invention.

If a user moves a mouse, the position of the mouse is displayed in an OSD overlay area according to the flowchart of FIG. 4. After some delay, the graphical data received from the computer is output and displayed at the mouse position in the OSD.

Referring to 601 of FIG. 5, when a user moves a mouse to the right, a mouse cursor 621 moves to the right, the computer must process the graphics, and then re-transmit graphical data in order to display the mouse cursor at a new position. The new position of the mouse cursor is illustrated with reference numeral 622. A wireless display apparatus, on the other hand, receives information on the cursor movement, and displays the position of the mouse in the OSD area as illustrated with reference numeral 651.

Through motion of a dot (illustrated with reference numeral 651) displayed in the OSD area, the user can see in which direction the mouse has moved. As denoted by reference numeral 623 of 602, the mouse cursor is output according to the graphical data received from the computer. For example, the mouse is displayed on the border of a window and the cursor shape is changed.

Further, the mouse position (illustrated with reference numeral 651) may appear or disappear from the OSD area. Because the cursor position is displayed in the OSD area, a user can see the new position of the mouse as soon as it has moved thereto. Especially, in an OSD area that is processed and displayed by a monitor, and thus, does not cause a problem for a computer processing unit. As illustrated with reference numeral 601 of FIG. 5, not until the mouse is moved by the user is the cursor position 651 displayed in the OSD area. If the mouse is moved, the cursor position 651 cannot be output.

When the mouse cursor is moved from 621 to 622, the OSD area outputs the position of the mouse pointer at 621, and may subsequently output 651 until the mouse reaches 622. Because the user can see the moving path of the mouse by referring to the position of the mouse pointer displayed in the OSD area, a delay of a few seconds in displaying the mouse cursor does not interfere with the work being done by the user.

As described above, according to an apparatus and a method of displaying a movement of an input device in an OSD area, according to aspects of the present invention, the following effect(s) can be realized. When the position of an input device, such as a mouse, is changed, the time required to update and display the position is reduced. A user can recognize the new position on the wireless display apparatus in real time.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of displaying an input device movement in an on-screen display (OSD) area in a wireless display apparatus, the method comprising:
receiving information on an input device movement according to the input device;
displaying a pointer position of the input device in an OSD area according to the information on the movement;
receiving graphical data, from a computer, containing information on the movement of the input device; and
outputting the graphical data at the displayed pointer position.

2. The method of claim 1, further comprising transmitting information on movement of the generated position according to the input device, wherein the graphical data reflects information on the movement of the position.

3. The method of claim 1, further comprising deleting images that displayed the pointer position of the input device on the OSD area after displaying the graphical data.

4. The method of claim 1, further comprising
storing the pointer position in a memory; and
updating the stored pointer position continuously according to the information on the input device movement.

5. The method of claim 1, wherein the input device is a mouse, a joystick, a tablet, or a touch panel.

6. A method of displaying movement of an input device in an OSD area in a wireless display apparatus, comprising:
generating movement information according to an operation;
transmitting the generated movement information to a wireless display apparatus; and
transmitting the information to a computer that outputs graphical data to the wireless display apparatus.

7. The method of claim 6 further comprising converting the movement information according to a resolution of the computer before the transmitting of the information to the computer.

8. The method of claim 6, wherein the input device is a mouse, a joystick, a tablet, or a touch panel.

9. A wireless display apparatus comprising:
an input-device control-signal receiving unit that receives information of an input device;
an OSD controller that displays a pointer position in an OSD area according to the received information;
an image-receiving unit that receives graphical data, from a computer, containing information on the movement of the input device; and
an output unit that outputs the graphical data at the displayed pointer position.

10. The apparatus of claim 9, further comprising a memory to store a current pointer position in memory to allow the OSD controller to calculate a new pointer position upon movement of the input device, wherein the memory provides a standard pointer position and is continuously updated when the input device is moved.

11. The apparatus of claim 9 further comprising transmitting information on movement of the pointer position generated according to handling the input device, wherein the graphical data reflects information on the pointer position movement.

12. The apparatus of claim 9, wherein the OSD controller deletes images that display a pointer position of the input device in the OSD area.

13. The apparatus of claim 9, wherein the input device is a mouse, a joystick, a tablet, or a touch panel.

14. The apparatus of claim 9, wherein the output unit is a plasma display panel, an organic light emitting diode, or a liquid crystal display.

15. A wireless display apparatus comprising:
an output unit including an OSD area where a pointer position is displayed when an input device is moved;
and a data-receiving unit that receives graphical data changed according to the pointer position of the input device using a wireless communication protocol, wherein the output unit outputs the graphical data.

16. The apparatus of claim 15 further comprising a data-transmitting unit that transmits information on movement of the generated position according to the input device to the computer, and the graphical data reflects information on the position movement.

17. The apparatus of claim 15, wherein the output unit is a plasma display panel, an organic light emitting diode, or a liquid crystal display.

18. A method of displaying a pointer position in an OSD area of a wireless display apparatus, the method comprising:
transmitting wirelessly a signal from an input device to a receiving unit in the wireless display apparatus;
displaying the signal in the OSD area of the wireless display apparatus as the pointer position;
converting the signal to a computer graphics resolution;
transmitting wirelessly the converted signal to a central processing unit;
processing the converted signal in the central processing unit to form a graphical data;
sending the graphical data wirelessly to the wireless display apparatus; and
displaying the graphical data at the pointer position in the OSD area of the wireless display apparatus.

19. The method of claim 18, wherein the displaying the signal in the OSD area of the wireless display apparatus as the pointer position includes displaying the moving path of the pointer position in response to movement of the input device.

20. A wireless display apparatus comprising:
an input device to wirelessly transmit a signal;
a first receiving unit to receive the transmitted signal;
a data converting unit to convert the signal to a computer graphics resolution signal;
a first data transmitting unit to transmit the computer graphics resolution signal;
a computer unit to receive the computer graphics resolution signal, process the computer graphics resolution signal into a graphical data, output the graphical data, and wirelessly transmit the graphical data; and
an output unit to display the signal from the input device as a pointer position and to display the graphical data at the pointer position.

21. The apparatus of claim 20, wherein the computer unit comprises:
a first data receiving unit to receive the computer graphics resolution signal;
a central processing unit to process the computer graphics resolution signal and output the graphical data;
an image compressing unit to compress the graphical data; and
a second data transmitting unit to transmit the compressed graphical data.

22. The apparatus of claim 20, wherein the input device comprises:
the data converting unit to convert the signal to the computer graphics resolution signal; and
the first data transmitting unit to transmit the computer graphics resolution signal.

23. The apparatus of claim 20, further comprising
a second data receiving unit to receive the compressed graphical data; and
an image restoring unit to restore the graphical data to display on the output unit.

24. The apparatus of claim 20, further comprising
an OSD controller to display the signal as the pointer position in an OSD area of the output unit; and
a memory to store a current pointer position in memory to allow the OSD controller to calculate a new pointer position upon movement of the input device, wherein the memory provides a standard pointer position and is continuously updated when the input device is moved.
